(19) United States
(12) Patent Application Publication
(10) Pub. No.: US 2020/0276539 A1
(43) Pub. Date: Sep. 3, 2020

(54) FILTER DEVICE HAVING A FLOW FITTING

(71) Applicants: SARTORIUS STEDIM BIOTECH GMBH, Goettingen (DE); DWI - LEIBNIZ-INSTITUT FUER INTERAKTIVE MATERIALIEN E.V., Aachen (DE)

(72) Inventors: Stefan WEISSHAAR, Adelebsen (DE); Martin LEUTHOLD, Goettingen (DE); Ulrich GRUMMERT, Bad Sooden-Allendorf (DE); Matthias WESSLING, Aachen (DE); Kristina BAITALOW, Aachen (DE); Jonas LOELSBERG, Aachen (DE)

(21) Appl. No.: 16/650,025

(22) PCT Filed: Sep. 17, 2018
(86) PCT No.: PCT/EP2018/075006

§ 371 Date: Mar. 24, 2020

(30) Foreign Application Priority Data
Sep. 25, 2017 (EP) 17192898.9

(51) Int. Cl. B01D 61/36; B01D 27/08

(52) U.S. Cl. CPC B01D 61/368; B01D 2315/00; B01D 27/08

(57) ABSTRACT

A filter device (10), in particular for a tangential flow filtration device, has at least one fluid inlet (22), at least one retentate outlet (24) and at least one permeate outlet (26). The filter device (10) further has at least one membrane (16) which separates a retentate section (18) from a permeate section (20) in the filter device (10). Arranged in the retentate section (18) and/or in the permeate section (20) is at least one flow fitting (28) which is not formed from a woven or non-woven fabric, but from a structured plastic part, silicone part, metal part or ceramic part.

The invention relates to a filter device, in particular for a tangential flow filtration device.

In typical tangential flow filtration devices, replaceable filter cartridges having flat membranes or spiral-wound modules having wound membranes are used as filter media. In order to reduce the formation of a cover layer on the filter medium and to achieve a sufficient filtration performance, suitable woven or non-woven fabrics are used as flow fittings. Examples of flow fittings are shown in EP 1 089 805 B1, US 2014/0231339 A1, U.S. Pat. No. 8,980,088 B2 (filter cartridge) and in WO 2015/200691 A1 (spiral-wound module). Such flow fittings are employed in the retentate channel and/or in the permeate channel, depending on the embodiment of the filter device. The flow fittings may be used as so-called spacers (in the retentate channel: “feed spacer”; in the permeate channel: “permeate spacer”) having a shaping function so that they form a flow channel or part thereof.

However, the use of flow fittings in filter devices is accompanied by several drawbacks. The technical possibilities with regard to available geometric structures are limited for manufacturing reasons. For instance, in the case of fabrics, the thread diameter, weave and thread spacing can only be varied to a very limited extent. As a result, the formation of the cover layer is not reduced in an optimum manner, inter alia. In addition, comparatively high undesirable pressure drops may occur. Furthermore, the shear load may have a negative effect on molecules in the liquid to be filtered. The shear load may lead to changes in the molecular properties. In bio-pharmaceutical products this manifests itself by a change in the mechanism of action or a reduction in long-term stability.

The integration of flow fittings in the form of non-woven or woven fabrics is generally complex. Due to the production steps required, the manufacturing costs of filtration modules are high. In many cases, an automation of the process steps is only possible to a limited degree. A further drawback is the risk of damage to sensitive membranes should they inadvertently come into contact with the fabric of a flow fitting, for example as a consequence of pressure surges during operation, which may ultimately lead to failure of the functioning of the filter device.

It is the object of the invention to provide a filter device in which the cover layer formation during a filtration process is reduced, the pressure drop in the retentate and/or permeate channel is decreased, and the manufacturing costs are reduced.

This object is achieved by a filter device having the features of claim 1. Advantageous and expedient further configurations of the filter device according to the invention are indicated in the dependent claims.

The filter device according to the invention is intended in particular for a tangential flow filtration device and comprises at least one fluid inlet, at least one retentate outlet and at least one permeate outlet. The filter device further comprises at least one membrane which separates a retentate section of the filter device from a permeate section in the filter device. Arranged in the retentate section and/or in the permeate section is at least one flow fitting which according to the invention is formed from a structured plastic part, silicone part, metal part or ceramic part.

The invention is based on the finding that the drawbacks of flow fittings made from woven or non-woven fabrics can be overcome in particular by suitably shaped plastic or silicone parts, but also by appropriate metal or ceramic parts. In this context, a structured plastic, silicone, metal or ceramic part according to the invention is understood to mean a preferably flat part, in particular a mat, having a three-dimensional structure which significantly influences the flow behavior as compared to a smooth surface. The configuration of the structure to be used can be adapted with regard to the respective application here, for example with a view to particularly shear-sensitive molecules or viscous liquids. It should be appreciated that it is not absolutely necessary for the entire flow fitting to exhibit such a structure as long as one or more structured sections exist which come into contact with the liquid flowing along and influence the flow behavior accordingly.

The use of structured flow fittings according to the invention, made from plastic, silicone, metal or a ceramic part, eliminates the previously necessary processing of fabrics, such as stamping and the attachment of sealing contours. The flow fittings according to the invention can be incorporated into the filter devices in less complex work steps.

Particularly preferred is a flow fitting which—as already indicated—is formed as a mat with structures that are raised relative to the mat. The liquid can flow along the mat and, in doing so, is influenced in its flow behavior by suitably shaped and arranged structures such that ultimately only a small amount of residue will be deposited on the filter medium without a large pressure drop occurring in the process.

With a view to a simplified machine production, the at least one flow fitting of the filter device according to the invention is preferably an injection molded part. Injection molded parts are suitable for automated series production, so that identical flow fittings of the same quality can be manufactured cost-effectively in large numbers of items.

The production of flow fittings in large numbers of items favors an embodiment of the filter device according to the invention, in which the at least one flow fitting is a separate component of the filter device. The flow fittings can be held available in sufficient quantities before they are incorporated into the filter devices.

However, according to a particularly preferred embodiment of the invention, the at least one flow fitting is formed integrally with another component of the filter device, in particular a housing component. Here, the flow fitting may either be manufactured simultaneously with the other component or applied to that component later, in particular in a multi-component injection molding process or by means of some other well-proven additive manufacturing process.

With a view to having as simple a configuration as possible of the retentate section or the permeate section of the filter device, it may be provided that the at least one flow fitting itself forms a flow channel in the retentate section and/or in the permeate section. In this way, additional parts or structures in these sections may be dispensed with.

According to a further aspect of the invention, the flow fitting includes an integrated sealing contour to seal the filter device. This means that the flow fitting can already be manufactured with a sealing contour, so that it is not necessary to subsequently join or attach a sealing contour, as is required for woven or non-woven fabric flow fittings.

One preferred configuration of the filter device according to the invention provides that the fluid inlet that opens into the retentate section and/or the retentate outlet leading out of the retentate section and/or the permeate outlet leading out of the permeate section is/are formed in a housing of the filter device.

The filter device according to the invention may also be realized with a multi-layer structure, in which a plurality of filter cells each having a respective retentate section and a respective permeate section separated by a membrane are stacked one on top of the other, a flow fitting being arranged in each retentate section and/or in each permeate section of the filter cell.

In such a multi-layer structure, a configuration is advantageous in which the flow fittings themselves have passages to form connecting channels in the filter device.

Further features and advantages of the invention will be apparent from the description below and from the accompanying drawings, to which reference is made and in which:

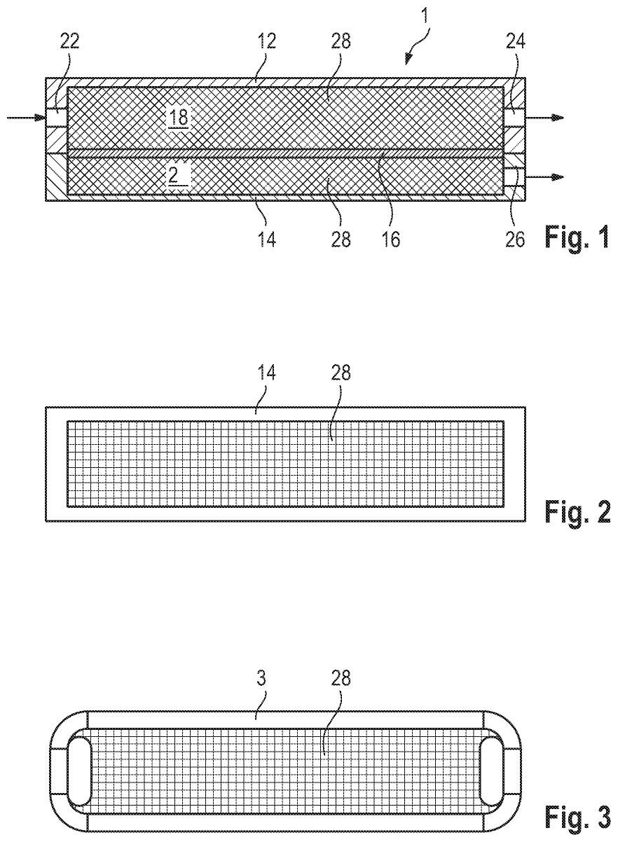

FIG. 1 shows a sectional side view of a filter device according to the invention with a membrane and two flow fittings;

FIG. 2 shows a top view of a flow fitting formed as part of a housing component of the filter device of FIG. 1;

FIG. 3 shows a top view of a flow fitting with an integrated sealing contour;

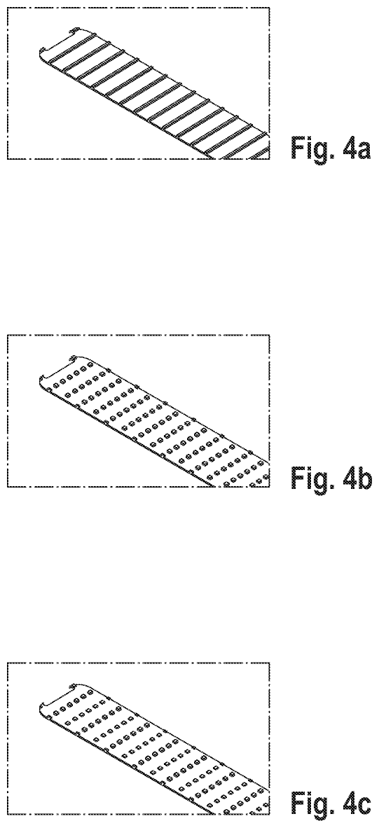

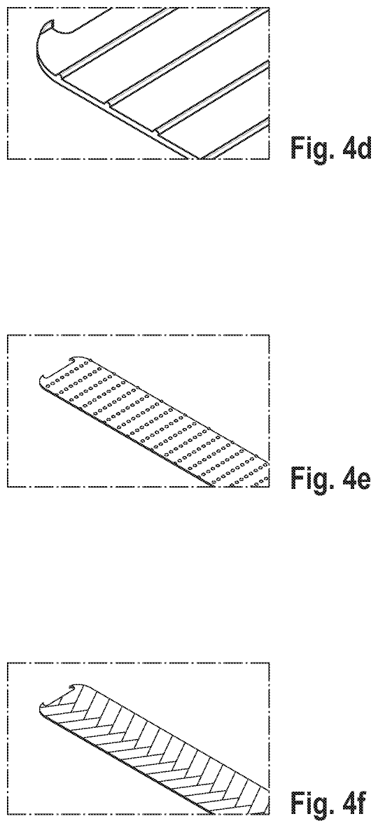

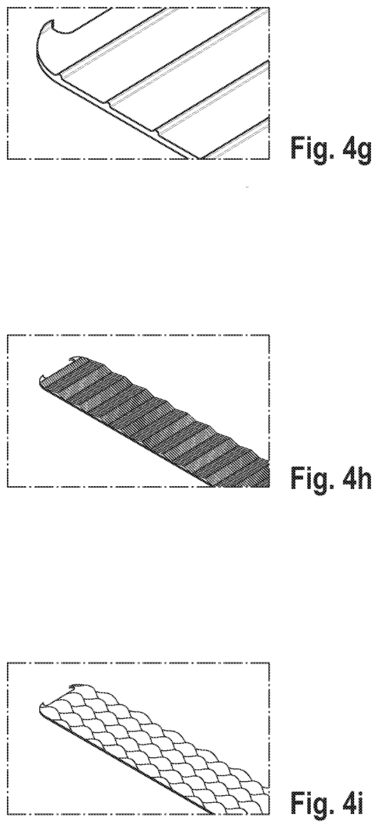

FIGS. 4a to 4i show various structures of flow fittings;

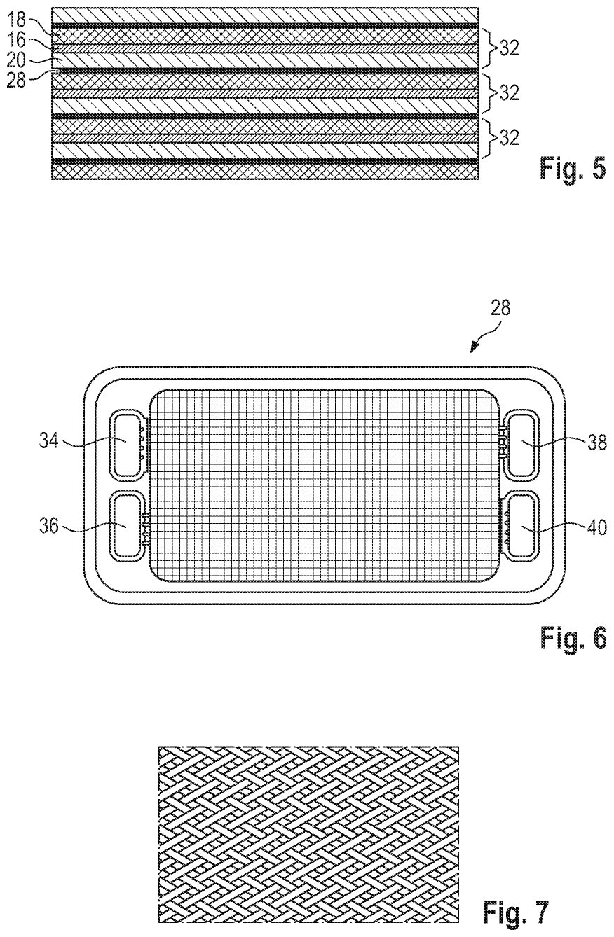

FIG. 5 shows a sectional side view of a filter device according to the invention with a plurality of membranes and flow fittings without a housing;

FIG. 6 shows a top view of a flow fitting of the filter device of FIG. 5;

FIG. 7 shows a detail of a flow fitting made from a fabric according to the prior art;

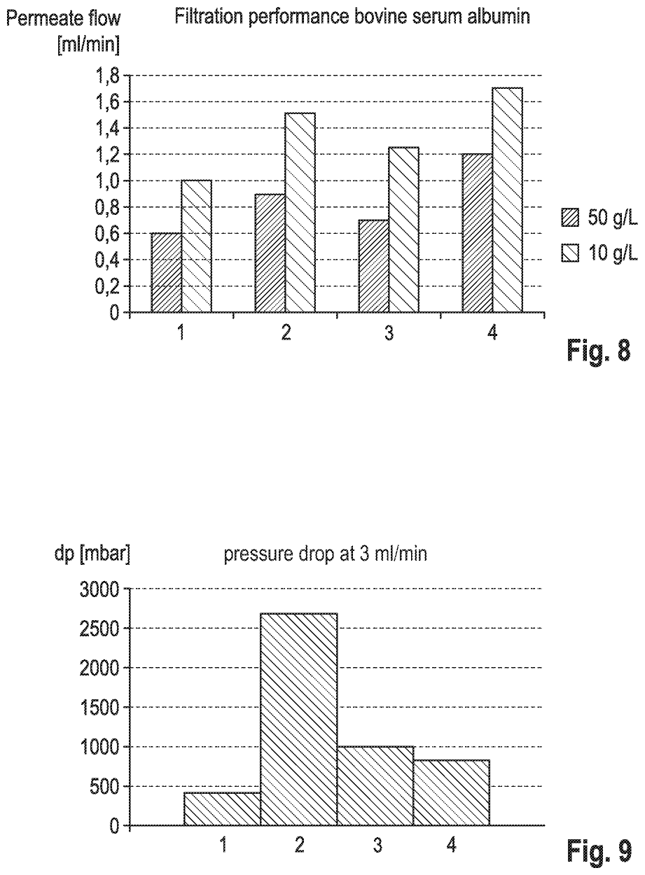

FIG. 8 shows a chart on the filtration performance when various flow fittings according to the invention are used, in comparison to the prior art; and

FIG. 9 shows a chart on the pressure drop when various flow fittings according to the invention are used, in comparison to the prior art.

FIG. 1 shows, by way of example, the construction of a filter device 10 configured as a module, here in the form of a filter cartridge, which is intended for use in a tangential flow filtration device. A membrane 16 is clamped in a housing, which here is composed of two housing components (top plate and bottom plate) 12, 14. The membrane 16 separates a retentate section 18 from a permeate section 20 in the filter device 10. A fluid inlet 22, which opens into the retentate section 18, is formed in the housing. Moreover, two separate fluid outlets 24, 26 are formed in the housing. A retentate outlet 24 leads out of the retentate section 18, while the permeate outlet 26 is an exit from the permeate section 20.

In the exemplary embodiment illustrated in FIG. 1, flow fittings 28 are inserted in both the retentate section 18 and the permeate section 20 of the filter device 10. The flow fittings 28 form a respective flow channel on both sides of the membrane 16. In this way, a first flow fitting 28 forms a retentate channel in the retentate section 18, which leads from the fluid inlet 22 over the membrane 16 to the retentate outlet 24, and a second flow fitting 28 forms a retentate channel in the permeate section 20, which leads below the membrane 16 to the permeate outlet 26.

The flow fittings 28 may each be inserted as a separate component into the housing of the filter device 10, or, as shown in FIG. 2, may be constructed as an integral part of the housing or of a housing component 12, 14.

FIG. 3 shows a special embodiment of the flow fitting 28 with an integrated sealing contour 30, i.e. the flow fitting 28 was manufactured together with the sealing contour 30 in the same production process. The sealing contour 30, which completely surrounds the flow fitting 28 on the outside, takes over the sealing of the filter device 10.

FIGS. 4a to 4i show details of differently structured flow fittings 28 by way of example. FIG. 4a shows a cuboid structure, FIG. 4b a cube structure with cubes of equal height, FIG. 4c a cube structure with cubes of different heights, FIG. 4d a semicircular structure, FIG. 4e a hemispherical structure, FIG. 4f a herringbone structure, FIG. 4g a wave structure, FIG. 4h a cone zigzag structure, and FIG. 4i a sinusoidal structure. The flow fittings 28 may be formed as mats with raised structural elements, as shown in the individual Figures. Specific structural parameters of the flow fittings 28, such as shape, height, width and spacing of the structural elements as well as the distance thereof from the filter medium, may vary. Furthermore, different structures may be combined with each other.

The manufacture of the flow fittings 28 is preferably carried out in an injection molding process using a suitable plastic material or, preferably, silicone. A configuration using metal or ceramics is also possible.

Basically, it is possible to construct the flow fittings 28 in one piece with other components, in particular with housing components 12, 14 of the filter device 10 (cf. FIG. 2). If, for example, the housing is formed from a particular material such as, e.g., PPTA, the flow fitting that is incorporated also consists of this material.

Alternatively, the flow fittings 28 may be subsequently applied onto other components of the filter device 10 and connected to them. Well-established additive production processes, such as multi-component injection molding, are suitable for this purpose.

FIG. 5 shows a multi-layer structure for a filter device 10. A plurality of filter cells 32, each including a membrane 16 as well as a retentate section 18 and a permeate section 20, are stacked on top of each other. The retentate section 18 and/or the permeate section 20 are provided with a flow fitting 28 and thereby constitute a retentate channel and/or a permeate channel, respectively. At least the inner flow fittings 28 each separate a retentate channel from a permeate channel of a neighboring filter cell.

As shown in FIG. 6, the flow fitting 28 may have additional passages 34, 36, 38, 40, which in the filter device 10 constitute parts of connecting channels in the filter device 10 for the supply and discharge of the liquid flows.

In the following, two of the above described flow fittings 28 having different structures and a flow fitting from the prior art are compared with each other as regards the filtration performance. FIG. 7 shows such a conventional prior art flow fitting formed from a woven fabric.

For the comparison, a filter device 10 having a membrane 16 with an effective filter area of 10 cm² was inserted into a tangential flow filtration device. The filtration performance was measured with the retentate section 18 equipped as follows: (1) no flow fitting (empty channel, 450 μm in height) as a reference; (2) flow fitting made from a woven fabric according to the prior art; (3) flow fitting 28 having a herringbone structure (cf. FIG. 4f); and (4) flow fitting 28 having a sinusoidal structure (cf. FIG. 4i). In the permeate section 20, the flow fitting was identical for all measurements. The filtration parameters were also the same for all measurements. A flow rate of 10 ml/min over the retentate channel was applied in each case. The transmembrane pressure was 2.2 bar. The filtration solution used was a solution with 50 g/l or 10 g/l bovine serum albumin in 10 mM phosphate buffer. The permeate flow was measured for 5 minutes.

FIG. 8 shows a chart of the amount of filtration vs. time for the different measurement setups. The left bars show the result for the solution concentration of 50 g/l and the right bars show the result for the solution concentration of 10 g/l. For both solution concentrations the flow fitting 28 with the sinusoidal structure (4) exhibits the highest filtration performance. While the filtration performance of the flow fitting 28 having the herringbone structure (3) is slightly lower than that of the flow fitting made from woven fabric according to the prior art, it is still higher than in the reference measurement without a flow fitting in the retentate section 18.

Furthermore, the pressure drop was determined for each measurement setup. To this end, a 78% glycerin/water mixture having a viscosity of approx. 50 mPas at 20° C. was pumped through the retentate channel at a volume flow rate of 3 ml/min. This viscosity also corresponds to protein solutions of higher concentrations (for example, 150-300 g/l of an antibody-containing solution).

FIG. 9 shows a chart of the pressure drop for the different measurement setups. The result is that the pressure drop of the flow fittings 28 (3) and (4) is considerably lower compared to the flow fitting made from a woven fabric according to the prior art.

Looking at both tests, it becomes apparent that in particular by using the flow fitting 28 with the sinusoidal structure, a high filtration performance in combination with a low pressure drop can be achieved.

The flow fittings 28 presented here are not only suitable for use in filter cartridges, but also in spiral-wound modules. The flow fittings 28 and the filter devices 10 with such flow fittings 28 may be employed not only in tangential flow filtration, but also in other filtration processes, in particular in the biopharmaceutical industry, but also in the food industry.

### LIST OF REFERENCE NUMBERS

10 filter device
12 housing component
14 housing component
16 membrane
18 retentate section
20 permeate section
22 fluid inlet
24 retentate outlet
26 permeate outlet
28 flow fitting
30 sealing contour
32 filter cell
34 passage
36 passage
38 passage
40 passage

1. A filter device for a tangential flow filtration device, comprising at least one fluid inlet, at least one retentate outlet and at least one permeate outlet kW, as well as at least one membrane which separates a retentate section from a permeate section in the filter device, at least one flow fitting being arranged in the retentate section and/or in the permeate section characterized in that the flow fitting is formed from a structured plastic part, silicone part, metal part or ceramic part.

2. The filter device according to claim 1, characterized in that the at least one flow fitting kW is formed as a mat with structures that are raised relative to the mat.

3. The filter device according to claim 2, characterized in that the mat has at least one of the following structures: cuboid structure, cube structure with cubes of equal height, cube structure with cubes of different height, semicircular structure, hemispherical structure, herringbone structure, wave structure, cone zigzag structure or sinusoidal structure.

4. The filter device according to claim 1, characterized in that the at least one flow fitting is an injection molded part.

5. The filter device according to claim 1, characterized in that the at least one flow fitting is a separate component of the filter device.

6. The filter device according to claim 1, characterized in that the at least one flow fitting is formed integrally with another component of the filter device.

7. The filter device according to claim 1, characterized in that the at least one flow fitting forms a flow channel in the retentate section and/or in the permeate section.

8. The filter device according to claim 1, characterized in that the at least one flow fitting comprises an integrated sealing contour.

9. The filter device according to claim 1, characterized in that at least one of the fluid inlet, the retentate outlet and the permeate outlet is formed in a housing of the filter device.

10. The filter device according to claim 1, characterized in that a plurality of filter cells each having a respective retentate section and a respective permeate section separated by a membrane are stacked one on top of the other, at least one flow fitting being arranged in each retentate section and/or in each permeate section of the filter cell.

11. The filter device according to claim 10, characterized in that the flow fittings have passages for forming connecting channels in the filter device.

12. The filter device according to claim 1, characterized in that the filter device is realized as a prefabricated module, in particular in the form of a filter cartridge or a spiral wound module.

13. The filter device according to claim 12, characterized in that the filter device is realized as a prefabricated module in the form of a filter cartridge or a spiral-wound module.

14. The filter device according claim 6, characterized in that the at least one flow fitting is formed integrally with a housing component.
